(19) United States
(12) Patent Application Publication
(10) Pub. No.: US 2013/0145028 A1
(43) Pub. Date: Jun. 6, 2013

(54) Access Control List

(71) Applicants: Sami Mohammed SHALABI, Winchester, MA (US); Cassandra Lynn Doll, Santa Clara, CA (US); James D. Reilly, Boston, MA (US); Maurice Bennett Shore, Carlisle, MA (US)

(72) Inventors: Sami Mohammed SHALABI, Winchester, MA (US); Cassandra Lynn Doll, Santa Clara, CA (US); James D. Reilly, Boston, MA (US); Maurice Bennett Shore, Carlisle, MA (US)

(73) Assignee: GOOGLE INC., Mountain View, CA (US)

(21) Appl. No.: 13/311,278

(22) Filed: Dec. 5, 2011

(51) Int. Cl. G06F 15/173

(52) U.S. Cl. 709/225

(57) ABSTRACT

A system, computer-implemented method, and computer-readable medium manage access control for a magazine edition. A set of roles are assembled that correspond to a principal. Each role defines a set of rules that specify access permissions to the magazine edition, defined at an edition level, a section level and a post level. A set of user access permissions is built, based on the access permissions. An access request is received from the principal, wherein the access request requires a set of necessary access permissions to be granted, defined at an edition level, a section level and a post level. It is determined if the set of user access permissions provides the necessary access permissions. When the user access permissions provide the necessary access permissions, the access request is granted, and otherwise the necessary access permissions, the access request is denied.

### BACKGROUND

1. Technical Field

The technical field is managing access to media content.

2. Background

Users gain access to media content via the Internet or the World Wide Web (or simply the “Web”). One aspect of providing media content is the control of access to the media content by users. Users may wish to perform various tasks related to the magazine edition. For example, these tasks may give the users the ability to retrieve, create, and edit content in a media application. As part of performing the tasks, users will generate access requests.

A media application needs to determine whether a given access request should be granted or denied, based on the identity of the user. As a part of controlling access, it is important to establish the relationship between a user and the media application. For example, a user may have different roles, wherein a role helps define what the user should be permitted to do, and what the user should be prevented from doing.

However, present approaches have significant limitations that restrict their ability to manage access control successfully. One limitation is that current approaches have limited granularity. These approaches fail to provide the flexibility that defining access control at multiple levels offers. Furthermore, present approaches hardcode specific access permissions rather than describing access permissions by rules, which also limits flexibility.

As a result, it is important to provide an approach to managing access control that will provide a simple, easy, and flexible way of associating permissions with users, as well as more specific control of permissions.

### BRIEF SUMMARY

A system, computer-implemented method and computer-readable medium for managing access control for a magazine edition are provided. A set of roles are assembled that correspond with an identity of a principal, wherein each role defines a set of rules that specify access permissions to the magazine edition, defined at an edition level, a section level and a post level. A set of user access permissions is built based on the access permissions defined by the set of roles. An access request is received from the principal for the magazine edition, wherein the access request requires a set of necessary access permissions to be granted. The set of necessary access permissions are defined at an edition level, a section level and a post level. It is determined if the set of user access permissions provides the set of necessary access permissions that are required by the access request. In response to determining that user access permissions provide the set of necessary access permissions, the access request is granted. In response to determining the user access permissions do not provide the set of necessary access permissions, the access request is denied.

Further embodiments, features, and advantages of the invention, as well as the structure and operation of the various embodiments of the invention are described in detail below with reference to the accompanying drawings.

### BRIEF DESCRIPTION OF THE DRAWINGS/FIGURES

The accompanying drawings, which are incorporated herein and form a part of the specification, illustrate embodiments of the invention and, together with the description, further serve to explain the principles of the invention and to enable a person skilled in the relevant art to make and use the invention.

FIGS. 1A-1C illustrate a system for magazine editions, according to an embodiment.

FIG. 1D is a block diagram of an access control unit that manages access control for a magazine edition, according to an embodiment.

FIG. 2A is a block diagram of an edition player, according to an embodiment.

FIG. 2B is an example display view of a current module for displaying multiple magazine editions, according to an embodiment.

FIG. 3 is a block diagram of an application data model, according to an embodiment.

FIG. 4A is a block diagram of a studio architecture, according to an embodiment.

FIG. 4B is a screen shot of an exemplary embodiment of a studio displaying a user interface.

FIG. 5 is a flowchart of a method for managing access control for a magazine edition, according to an embodiment.

FIG. 6 is a diagram of the relationship between a principal, a role set, associated rules, and associated access permissions, according to an embodiment.

FIG. 7 is a diagram showing potential roles and permissions available at various levels of granularity, according to an embodiment.

FIG. 8 is a block diagram of a computer system in which embodiments of the invention can be implemented.

FIG. 9 is a set of exemplary permission tables that illustrate an example of how user permissions are processed.

Various embodiments of the invention are described below with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF EMBODIMENTS

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

The approaches to managing access control that are described herein operate in the context of a magazine edition. Hence, an exemplary version of a magazine edition for which access control may be managed will be discussed, in order to clarify a potential environment in which embodiments may operate. Aspects of implementing access control will be discussed as features that may be incorporated into a magazine edition.

The structure of a magazine edition may be defined at multiple levels, such as an edition level, a section level and a post level. Current approaches define access control equivalent to the edition level.

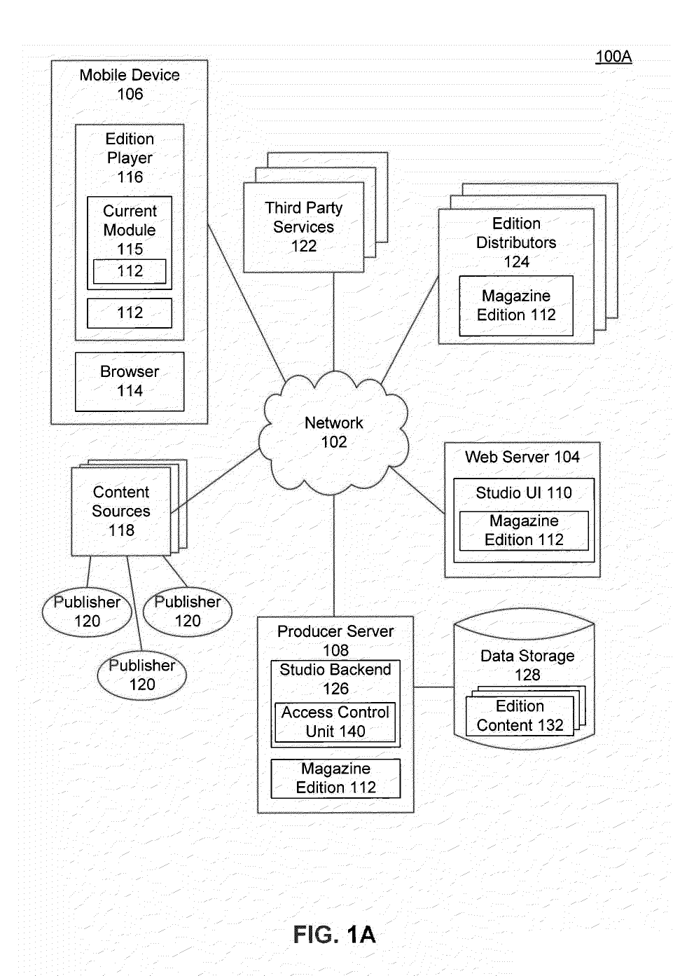

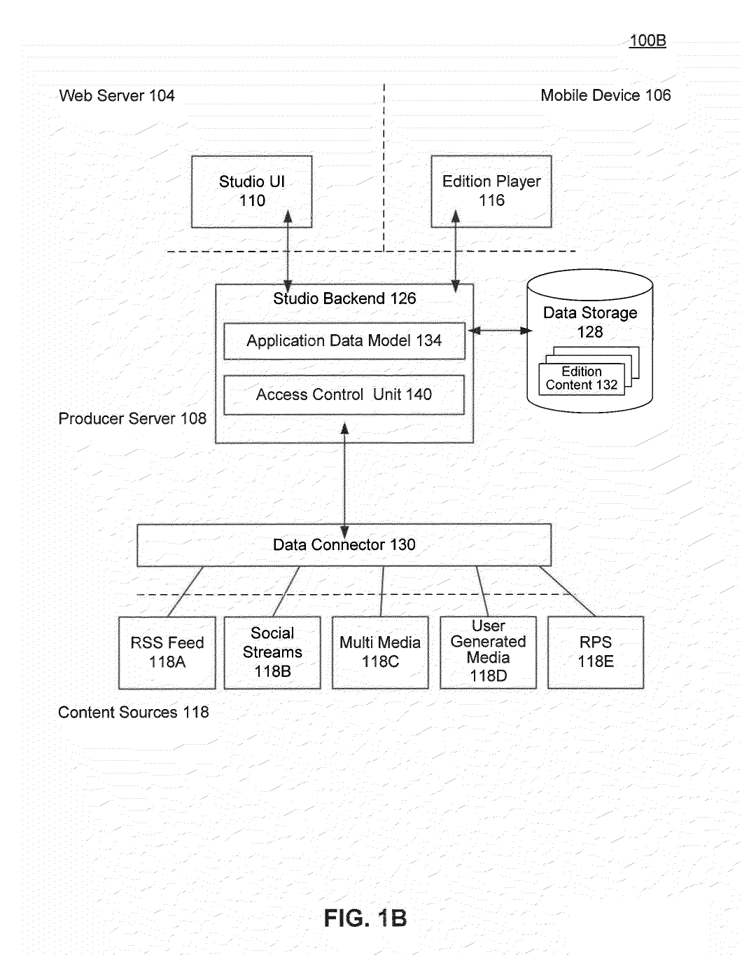

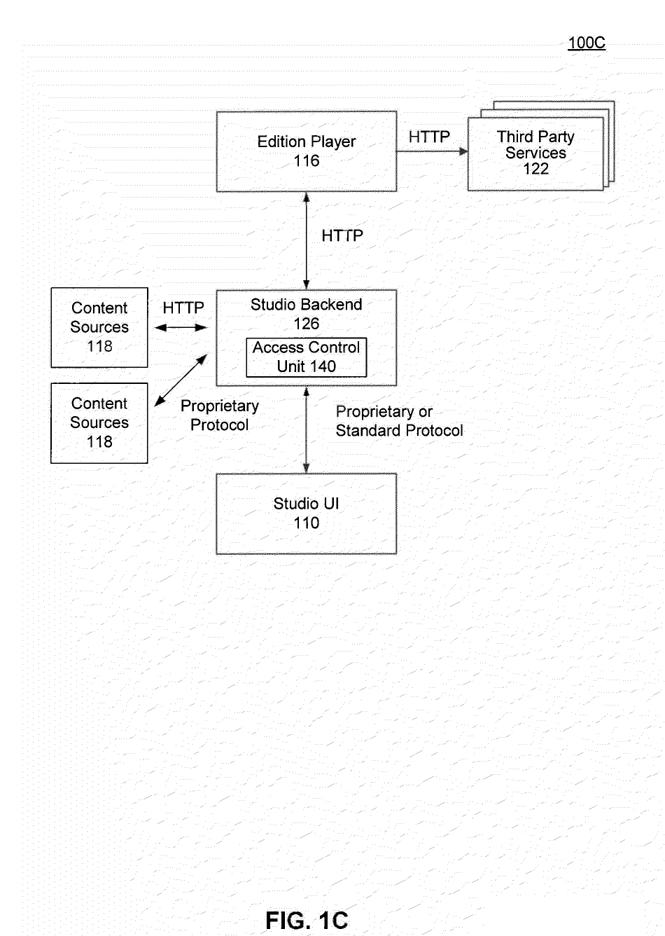

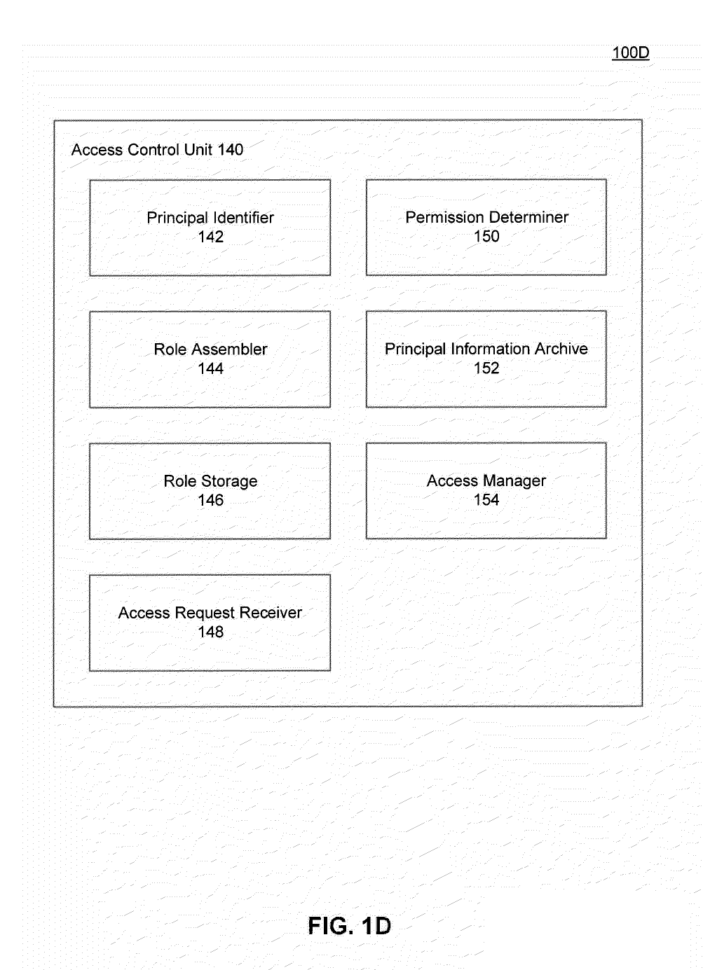

FIG. 1A is a block diagram 100A of a distributed system environment. Distributed system environment 100A includes one or more networks 102, web sewers 104, producer servers 108 and mobile devices 106.

Network 102 may be any network or combination of networks that can carry data communications. Such a network 102 may include, but is not limited to, a local area network, metropolitan area network, and/or wide area network such as the Internet. Network 102 can support protocols and technology including, but not limited to, World Wide Web (or simply the “Web”), protocols such as a Hypertext Transfer Protocol (“HTTP”) protocols, and/or services. Intermediate web servers, gateways, or other servers may be provided between components of the system shown in FIG. 1A, depending upon a particular application or environment.

Web server 104 is a computing device or an application executing on a computing device that hosts multiple websites. A website is one or more resources associated with a domain name and hosted by one or more web servers 104. An example website is a collection of webpages formatted in hypertext markup language (HTML) that can contain text, images, multimedia content, and programming elements, such as scripts. Web server 104 hosts studio user interface (“UI”) 110. Studio UI 110 enables users, such as publishers 120, to design interactive magazine editions 112 that may be distributed to multiple mobile devices 106. Publisher 120 may access studio UI 110 using a web address that is hosted on web server 104. Once accessed, publisher 120 may use studio UI 110 to design the layout of magazine edition 112 and configure content sources 118 for mobile devices 106 having different specifications. However, it may be noted that the ability of users, such as publishers 120, to access magazine edition 112 at studio UI 110 will be controlled and regulated by access control unit 140, as discussed in greater detail below.

In another embodiment, publisher 120 may download studio UI 110 onto a mobile device 106 as a standalone application or as a plugin or extension to a browser.

Magazine edition 112 may be designed using studio UI 110. Magazine edition 112 displays edition content to users in, for example, a format specified by publishers 120. However, unlike conventional applications that include a separate version for each mobile device having a particular operating platform, edition content displayed using magazine editions 112 may be displayed on mobile devices 106 in a format that is specified by a particular publisher, regardless of the native operating platform particular to mobile device 106. Magazine editions 112 may also layout edition content according to the size of a display screen of mobile device 106.

Mobile device 106 is an electronic device that is under the control of a user and is capable of requesting and receiving resources over network 102. Example mobile devices 106 are mobile communication devices such as smart phones and tablet computers. Mobile device 106 typically includes an application, such as a web browser (or simply browser) 114. A user controls browser 114 to request resources over network 102. A user requests a resource by typing the website address associated with the resources that is stored on web server 104. For example, a user, such as publisher 120 may use browser 114 to access studio UI 110 to design an interactive magazine edition using mobile device 106.

Mobile device 106 also includes edition player 116. Edition player 116 displays magazine editions 112 to users. Magazine edition 112 displays dynamic media content on mobile devices 106, where mobile devices have different specifications and display screen size. Edition content included in magazine editions 112 includes content downloaded to magazine editions 112 using content sources 118. To display magazine editions 112, edition player 116 may use a current module 115 or display edition content using edition player 116. Once again, the ability of an edition player 116 to access magazine edition 112 will be constrained by access control unit 140.

Current module 115 stores magazine editions 112 which are published by publisher 120. Current module 115 may be downloaded to mobile device 106 from, for example, producer server 108 using network 102 or using another interface. Typically, once current module 115 is downloaded to mobile device 106, a user uses current module 115 to subscribe to magazine editions 112. Once subscribed, current module 115 uses mobile device 106 to download magazine editions 112 from producer server 108, or edition distributor 124. Current module 115 also updates magazine edition 112 with new edition content. In an embodiment, current module 115 also provides a user with a listing of recommended magazine editions 112 that may be of interest to the user and that a user may subscribe to. As before, the ability of current module 115 to access magazine edition 112 will be constrained by access control unit 140.

Producer server 108 includes studio backend 126. Studio backend 126 allows for a design, development and implementation of magazine editions 112. Studio backend 126 communicates with studio UI 110 when publisher 120 uses studio UI 110 to design magazine edition 112.

However, while various types of use have been described above in which producer server 108 provides access to content, such as through studio UI 110 or edition player 116, such access is not automatic. Producer server 108 also includes access control unit 140 as a constituent part of studio backend 126. Access control unit 140 manages access control for magazine edition 112.

The term “access”, as used herein, includes any set of permissions to read, write, remove or add to content in magazine edition 112. As studio backend 126 is called upon to provide access to magazine edition 112, access control unit 140 helps to ensure that users are only provided with types of access to which they are entitled. Furthermore, access control unit 140 provides additional flexibility and granularity by allowing for access control at multiple levels of magazine edition 112, and by allowing for access control based on roles corresponding with the identity of the user. These roles define rules that specify which access permissions the user has. Furthermore, the rules operate at several levels of magazine edition 112, including an edition level, a section level and a post level. Based on the permissions defined for a user, access control unit can determine if the access request made by the user should be granted or denied. The internal structure and operation of access control unit 140 are discussed in greater detail with FIG. 1D, below.

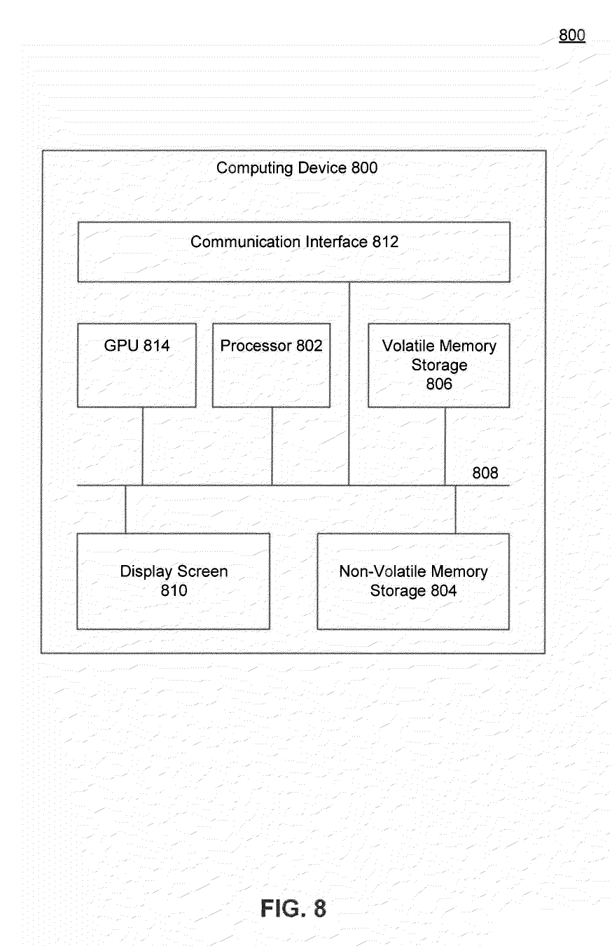

Once publisher 120 completes designing magazine edition 112 using studio UI 110, magazine edition 112 is uploaded to producer server 108 for storage and distribution. In an embodiment, magazine editions 112 may be stored on producer server 108 in a memory storage described in detail in FIG. 8. In another embodiment, publisher 120 may upload magazine edition 112 to edition distributors 124. A user may access edition distributor 124 and download magazine edition 112 to mobile device 106. However, it should be noted that user access to magazine edition 112 will be managed by access control unit 140. Thus, access will only be allowed if the user has appropriate access permissions, as discussed above. In an embodiment, once publisher 120 decides to distribute an upgraded magazine edition 112, mobile devices 106 that include a previous version of magazine edition 112 are synchronized with the upgraded magazine edition 112, as permitted by access control unit 140.

Content sources 118 provide edition content 132 to magazine edition 112. Example content sources 118 include data feeds, RSS feeds, social streams, user-generated media sources, multi-media sources via media RSS, etc. Content source 118 is typically associated with a publisher 120. Publisher 120 owns a particular content source 118 and controls edition content 132 that is distributed via content sources 118 over network 102.

Producer server 108 receives edition content 132 from content sources 118. Once received, producer server 108 stores edition content 132 in data storage 128. Data storage 128 may be a memory storage described in detail in FIG. 8. In an embodiment, data storage 128 may include a database for storing edition content 132. When magazine edition 112 executing on edition player 116 requests edition content 132, access control unit 140 determines based on the identity of the user whether the particular type of access should be allowed for that user. Aspects of this access control are discussed in greater depth, below. If the access request is producer server 108 is granted, edition content 132 is retrieved from data storage 128 and transmits edition content 132 to edition player 116. If the access request is denied, edition player 116 may handle this situation in a variety of ways. For example, the user may be provided with an alert letting him or her know that they have insufficient access permissions to grant their access request. An additional approach is to provide the user with the ability to login to a role with more access permissions.

Third party services 122 provide services to magazine editions 112. For example, third party services 122 provide streaming video that may be accessed by a uniform resource locator (“URL”) link included in magazine edition 112. In another example, third party services 122 determine that a user read a particular article included in magazine edition 112. In another example, third party services 122 provide advertisements for display within magazine edition 112. In another example, third party services 122 provide check out services for merchandise items that are provided for purchase within magazine edition 112.

Edition distributors 124 distribute applications, such as magazine editions 112 to mobile devices 106. For example, when publisher 120 designs magazine edition 112, publisher 120 may elect a particular edition distributor 124 to distribute magazine edition 112. When publisher 120 elects to distribute magazine edition 112 using a particular edition distributor 124, magazine edition 112 is uploaded to edition distributor 124. However, as discussed, distribution of magazine edition 112 is governed by access permissions associated with the user. For example, permissions may associated with a payment status of the principal. As an illustration of this approach, a user may then use mobile device 106 to access edition distributor 124 and upload magazine edition 112 onto mobile device 106 for an agreed upon fee.

FIG. 1B is a block diagram 100B of components in distributed system 100 that generate and distribute magazine editions.

As described herein, content sources 118 provide edition content 132 that is distributed across the web via network 102. For the edition content 132 to be distributed using magazine editions 112, content sources 118 are connected to producer server 108. In an embodiment, data connector 130 connects multiple content sources 118 and retrieves edition content 132.

Data connector 130 receives data from content sources 118. Data connector 130 may receive edition content 132 from content sources 118 in real-time or at configurable intervals that may be set by a system administrator. Once data connector 130 receives edition content 132 from content sources 118, data connector 130 transmits edition content 132 to data storage 128.

As described herein, data storage 128 distributes data from content sources 118 to magazine editions 112. For example, mobile device 106 may request data for particular magazine editions 112 at configurable time intervals that may be configured by the user subscribing to magazine editions 112.

Studio backend 126 receives the designed magazine editions 112 from studio UI 110. As described herein, studio UI 110 allows publishers 120 to design dynamic and interactive magazine editions that display edition content 132 provided by their content sources 118. Once publisher 120 completes designing magazine edition 112, publisher 120 uploads magazine edition 112 to studio backend 126. Access control unit 140 acts as part of studio backend 126 to determine what access should be provided to magazine editions 112. For example, access control unit 140 manages access to content at studio backend 126 by studio UI 110 and edition player 116. Studio backend 126 then stores the uploaded magazine editions 112 on producer server 108 and/or distributes magazine editions 112 to mobile devices 106 or edition distributors 124.

Studio backend 126 includes application data model 134. Application data model 134 (described in detail below), includes a format that displays edition content 132 within magazine editions 112. When publisher 120 uses studio UI 110 to create a particular magazine edition 112, studio UI 110 presents publisher 120 with application data model 134 framework that publisher 120 may configure to include edition content 120 for presentation to a user. Application data model 134 operates in tandem with access control unit 140 so that access control unit 140 only allows appropriate content access.

Upon a user request from mobile device 106, studio backend 126 may distribute magazine editions 112 to mobile devices 106. Each magazine edition 112 includes application data model 134 that is configured by publisher 120. However, before the user request is granted, access control unit 140 will ascertain if the user request was generated by a user with sufficient access permissions, given the nature of the request. This process is discussed in greater depth, below.

When magazine edition 112 is uploaded to mobile device 106, magazine edition 112 is populated with edition content 132. For example, producer server 108 provides edition content 132 from data storage 128 to magazine edition 112. As edition content 132 is updated with new edition content 132 from content sources 118, producer server 108 synchronizes edition content 132 included in magazine edition 112 with the new edition content 132 that is included in data storage 128.

In an embodiment, the synchronization may occur at configurable time intervals that may be configured by a user using mobile device 106. For example, a user may configure magazine edition 112 to query data storage 128 for new content every hour, every twelve hours, once a day, when requested by a user, etc. In a further embodiment, magazine edition 112 receives edition content 132 from data storage 128 that has been updated since the previous synchronization period, as to minimize the transmission of data over network 102. Furthermore, access control unit 140 may provide that synchronization will synchronize content in a way that is in accordance with the access permissions of the principal.

FIG. 1C is a block diagram 100C that describes an exemplary communication interface between the components within the distributed system.

For example, edition player 116 may communicate with studio backend 126 using HTTP over network 102. Edition player 116 may also communicate to third party services 122 and edition distributors 124 using HTTP. As discussed, the access of edition player 116 to information from studio backend 126 is regulated and controlled by access control unit 140, based on the identity of the principal, using edition player 116.

Studio UI 110 may communicate with studio backend 126 using a Google Web Toolkit (“GWT”) infrastructure. A person skilled in the art will appreciate that GWT allows web application developers to design JavaScript front-end applications using Java source code. In an embodiment GWT uses protocol buffers, also known to a person of ordinary skill in that art, to pass data that includes magazine editions 112, templates, edition content 132, etc., between studio UI 110 and studio backend 126. Once again, access control unit 140 acts to ensure that a user of studio UI 110 is only able to access aspects of magazine editions 112 that he or she should be allowed to access.

Studio backend 126 also communicates with a variety of content sources 118. In one embodiment, studio backend 126 may be configured to communicate with content sources 118 using a proprietary communication protocol that is specified by a particular content source 118. In another embodiment, studio backend 126 may also communicate with content sources 118 using HTTP.

FIG. 1D is a block diagram 100D of an access control unit that manages access control for a magazine edition, according to an embodiment. Access control unit 140 is a constituent part of producer server 108, and is included within studio backend 126 as has been previously discussed. Access control unit 140 includes a variety of functional subsystems that cooperate to manage access control for a magazine edition. These functional subsystems may include a principal identifier 142, a role assembler 144, a role storage 146, an access request receiver 148, a permission determiner 150, a principal information archive 152, and an access manager 154. However, it may be noted that not every embodiment may include all of these subsystems, in that certain embodiments may omit certain subsystems, or use other systems in lieu of those discussed here. An exemplary access control unit 140 that incorporates these subsystems is presented as an example to clarify the operation of access control unit 140.

Access control unit 140 begins its operation by identifying a principal, using principal identifier 142. In this context, the term “principal” denotes an identified user of the system, such that the access control unit 140 is able to associate a certain set of access permissions with the principal. Additionally, principals are the source of access requests. Principal identifier 142 may operate in conjunction with principal information archive 152. For example, principal identifier 142 may access principal information archive 152 to access information about which accounts exist for potential principals. Principal identifier 142 may use a variety of approaches to establish the identity of the principal. Generally, approaches to identifying the principal may include receiving login information from a principal, and verifying the login information to identify and authenticate the principal. For example, a very simple and traditional way of accomplishing this goal is to ask the principal for a textual user id and password, and use this information to establish an account that corresponds to the principal, thereby identifying the principal. It should be recognized that a wide variety of potential login information may be relevant. For example, in addition to textual information, the principal may use biometric data as login information for improved security. Additionally, it is possible that the principal may have already identified himself or herself before access control unit 140 is necessary. In this case, principal identifier 142 can request information that establishes the identity of the principal from another part of the embodiment that is aware of the identity of the principal.

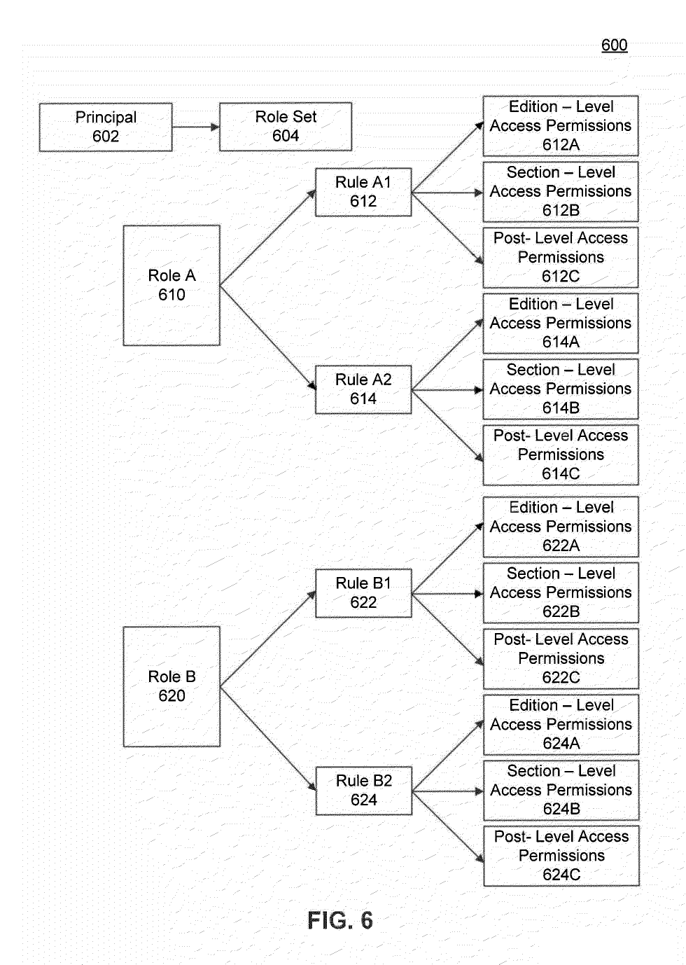

After principal identifier 142 has established the identity of the principal, role assembler 144 can use this identity information to assemble a set of roles corresponding with the identity of the principal, wherein each role defines a set of rules that specify access permissions to the magazine edition, defined at an edition level, a section level, and a post level. Role assembler 144 gathers a set of roles from role storage 146 that correspond with the identity of the principal. While role storage 146 is characterized in FIG. 1D as being a part of access control unit, role storage 146 may also be stored elsewhere in a system embodiment. Once role assembler 144 has performed the initial task of assembling the set of roles, it may then perform the subsequent task of building a set of user access permissions based on the access permissions defined by the set of roles. This process is discussed in greater depth in connection with FIGS. 6-7 and 9, below. After the set of user access permissions have been built, it will be possible to determine whether or not a given access request should be granted.

This process of determining whether or not an access request should be granted begins with the operation of access request receiver 148. Access request receiver 148 receives a specific access request from the principal. For example, an access request might include a request to view, design, edit, remove, or create new, with respect to a piece of content. For example, an international editor might want to edit a photograph of a crime victim to obscure the victim's face. Access request receiver 148 can then establish that such access requires view permission at the edition and section level and edit permission at the post level. It may be noted that these permissions need to be defined for a particular edition, section, and post. For example, view permission defined for the entertainment section is not relevant here, what is relevant is view permission for the international section.

Permission determiner 150 can then establish which permissions are necessary, and whether the user has these permissions. Continuing the earlier example, permission determiner might establish that the international editor has view access permissions to the whole edition, and view and edit permissions to the international section, as well as edit permissions for a specific photograph at the post level that the editor wishes to change. On this basis, the international editor is entitled to the requested access.

As discussed above, principal information archive 152 includes information about user accounts that can be used to help identify a principal.

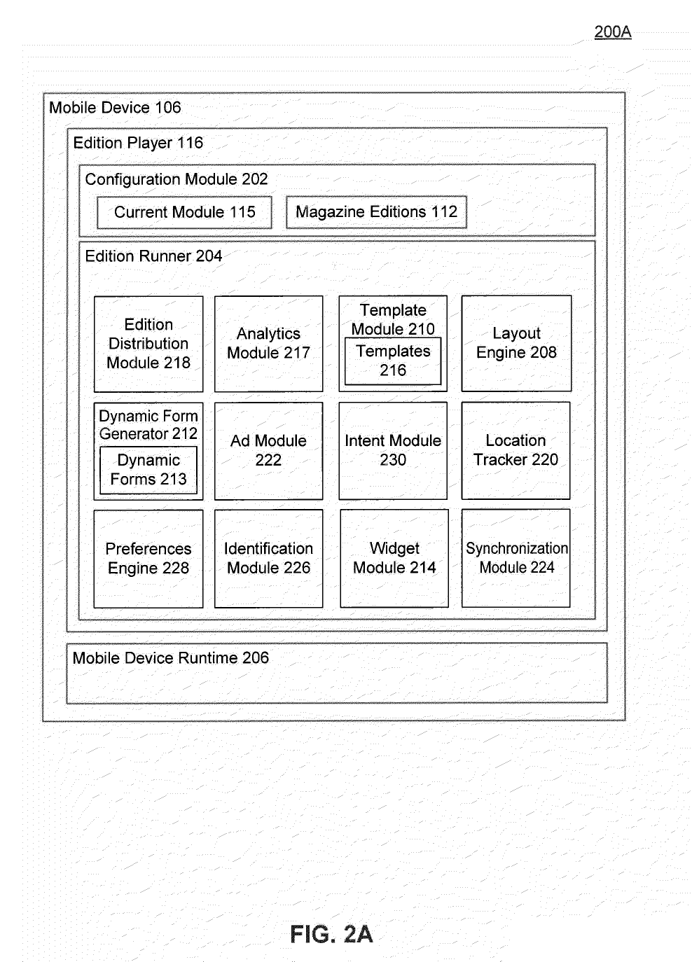

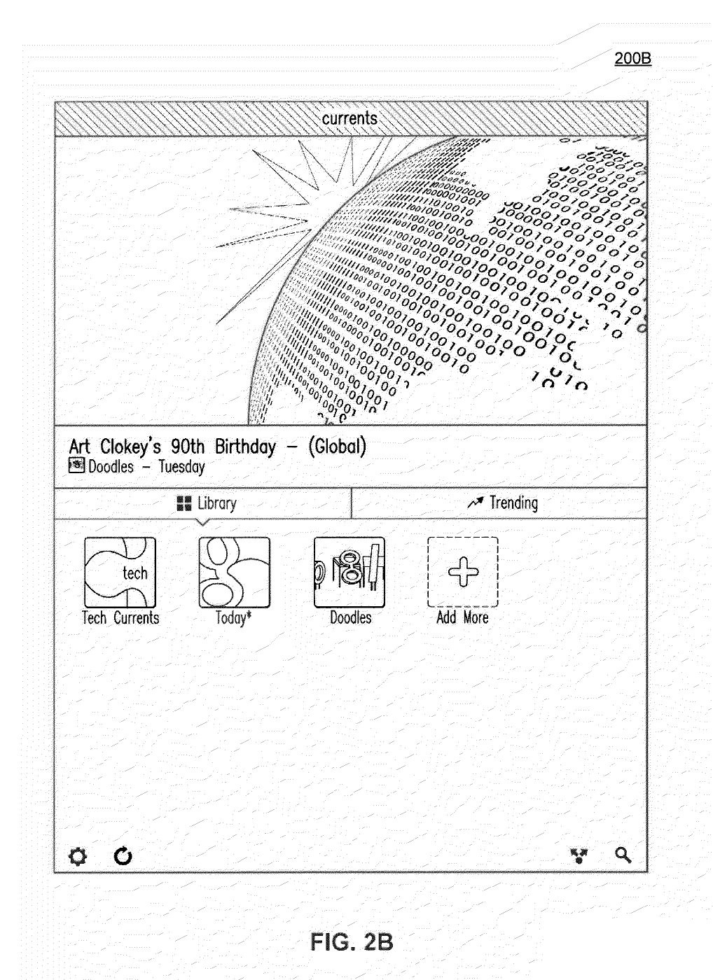

FIG. 2A is a block diagram 200 of an edition player. As described herein, edition player 116 displays magazine editions 112 to a user.

Edition player 116 includes a configuration module 202. Configuration module 202 determines a configuration mode that displays magazine edition 112 on edition player 116. For example, configuration module 202 may be configured to display magazine editions 112 using current module 115, in one embodiment. In another embodiment, configuration module 202 may be configured to display a single instance of magazine editions 112.

Edition runner 204 executes a configuration included in configuration module 202 and displays magazine editions 112. Example configuration may be executing a single instance of magazine edition 112 or executing current module 115 that provides a user with a selection of multiple magazine editions 112.

Edition runner 204 includes a layout engine 208. Layout engine 208 formats media content for display on mobile devices 106 having different specifications. Layout engine 208 receives edition content 132, using, for example, an HTML stream and generates a multi-column layout of edition content 132 that is appropriate for the display screen size and orientation of mobile device 106. Layout engine 208 interacts with template module 210, dynamic form generator 212 and widget module 214.

Template module 210 includes templates 216. Templates 216 control the rendering of the media content in magazine edition 112. Templates 216 may be native templates that are optimized for executing on edition runner 202, as they use the core mobile device runtime 206 libraries. Templates 216 may also be publisher 120 designed templates that display media content in a format designed by publisher 120. When magazine edition 112 is uploaded to mobile device 106, it stores templates 216 in template module 210.

Analytics module 217 tracks magazine editions 112, sections and articles within each magazine edition 112 viewed or read by a user. Analytics module 217 may compile a listing of the read content. The listing may be sent to publisher's 120 analytic account for determining edition content 132 that is interesting to users. The listing may also be sent to the user's account so that edition player 112 may provide a user with a history of edition content 132 that a user has read and/or accessed. Analytics module 217 may also track sections and articles within magazine editions 112 when a user browses magazine editions 112 offline (for example, without access to network 102). Once mobile device 106 is able to access network 102, analytics module 217 uploads the listing to publisher's 120 analytic account and/or user's account.

Edition distribution module 218 communicates with other applications, and distributes magazine editions 112 to third parties. Example third parties may include popular social networking sites, microblogging services, email accounts associated with users, etc., to name a few. Edition distribution module 218 may be accessed within magazine edition 112 when a user is reading a particular article or section and causes edition player 116 to distribute the read content.

Location tracker 220 identifies a location, such as latitude and longitude location of mobile device 106. Once the location of mobile devices 106 is identified, edition content 132 included in magazine edition 112 may be tailored to a location of mobile device 106. Additionally, the location information may be incorporated into the operation of access control unit 140, such that rules associated with roles are at least partially based on the location of mobile device 106.

Advertisement module 222 inserts advertisements into edition content 132 displayed by magazine edition 112. Advertisement module 222 determines where and when to include advertisements within magazine edition 112. For example, when layout engine 208 renders edition content 132 on a mobile device 106 in a way that includes an unfilled space, advertisement module 222 detects the unfilled space and queries an advertisement system to select an advertisement for inclusion in the unfilled space in real-time. Advertisement module 222 also communicates with various advertising entities that provide advertisement module 222 with advertisements for display within magazine edition 112.

Dynamic form generator 212 generates dynamic forms 213. Dynamic forms 213 render an arbitrary section within magazine edition 112 based on metadata provided by individual users. For example, dynamic forms 213 may be used to display submissions by individual users who, for example, practice citizen journalism.

Synchronization module 224 communicates with a studio backend 126 and retrieves edition content 132 from data storage 128. Synchronization module 224 also identifies the subscriptions that a user subscribed to using particular magazine editions 112 and synchronizes the edition content 132 included in the subscriptions with edition content 132 provided by content sources 118. The synchronization provided by synchronization module 224 is also regulated by access control module 140, such that when synchronization occurs the user is only granted access to information in a manner to which he or she is entitled.

Widget module 214 enhances edition content 132 displayed in magazine edition 112. For example, when a slide show is included in edition content 132, widget module 214 renders the slide show. In another example, when edition content 132 includes geo-coordinates, widget module 214 launches an application that displays a map. In another example, when edition content 132 includes a video application, widget module 214 launches a video display application, etc. A person skilled in the art will appreciate that the embodiments above are given by way of example and not limitation and that other means for enhancing edition content 132 may be used.

Identification module 226 identifies a user that uses mobile device 106 and subscribes to particular magazine editions 112. Identification module 226 may provide information about the identity of a user to principal identifier 142 within access control unit 140.

Preferences engine 228 determines the configuration of a user. For example, a user may configure time intervals for when magazine edition content is synchronized with studio backend 126.

Mobile device runtime 206 executes edition runner 204. Mobile device runtime 206 is a runtime that is native to mobile device 106. Mobile device runtime 206 allows a user to use edition player 116 to view magazine editions 112 on mobile device 106. Typically, mobile device 106 includes different mobile device runtimes 206 that execute mobile device 106 specific operating platforms.

FIG. 2B is an example display view of a current module for displaying multiple magazine editions, according to an embodiment. It provides an example screenshot of several magazine editions that a user may access. If the user chooses to access a magazine edition, the access request is handled appropriately by access control unit 140 as discussed above.

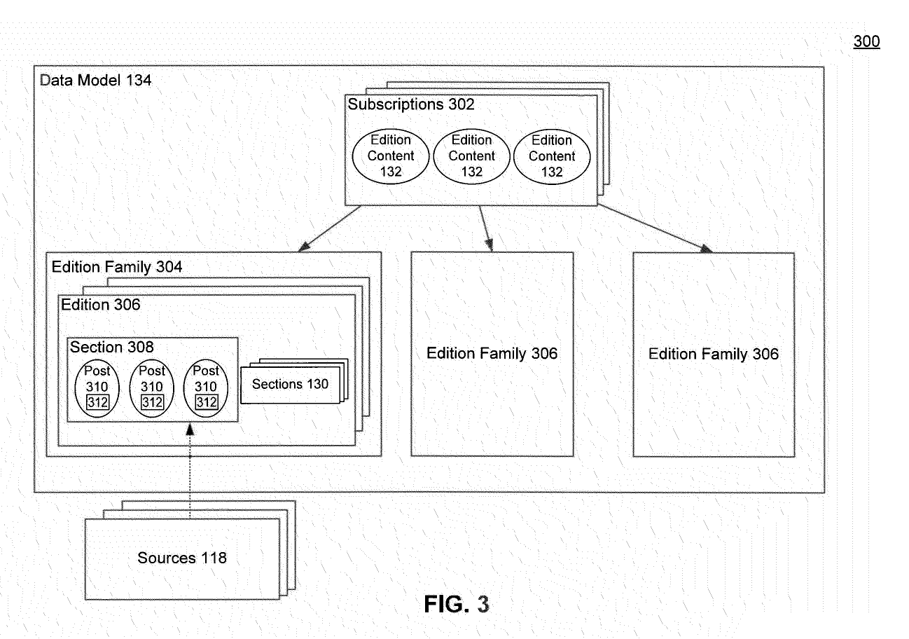

FIG. 3 is a block diagram 300 of a media application data model, according to an embodiment. Application data model 134 is a data model that magazine edition 112 uses to display edition content 132. When publisher 120 builds magazine edition 112 using studio UI 110, it configures edition content 132 into categories within application data model 134.

Application data model 134 includes multiple subscriptions 302. Each subscription 302 is a subscription to content source 118 from which a user subscribes to receive edition content 132 within magazine edition 112. A user may wish to subscribe to his own content source 118 when a user publishes content source 118 or may wish to subscribe to a third party's (e.g. publisher's 120) content source 118. Access permissions associated with a user by access control unit 140 may be partially regulated based on subscriptions 302 provided within the context of application data model 134.

Magazine edition 112 includes multiple edition families 304 or a single edition 306. Each edition family 304 receives edition content 132 from a particular content source 118. Edition content 132 in each edition family 304 may be distributed among multiple editions 306. Example editions 306 for an edition family 304 may include news content, blog content, video content, etc. Typically, publisher 120 may decide which edition content from source 118 to include in a particular edition 306. Additionally, when publisher 120 designs each edition 306 using studio UI 110, multiple designers associated with a particular publisher 120 may design a particular edition 306 or a set of editions 306 at the same time.

Editions 306 may include multiple sections 308. Sections 308 organize edition content 132 that is provided from content sources 118. For example, edition 306 that includes news content may include a news section and a style section. In another example, edition 306 that includes travel content may include multiple travel sections where each section 308 corresponds to a different region in the world. Each section 308 also includes a table of contents, header, templates 216 for laying out edition content 132 on various mobile devices 106, content source identifiers, etc.

Each section 308 may also include a section type. Section type allows studio UI 110 to optimize the presentation of edition content 132 that is included in section 308 of a particular type. For example, section types may include an RSS feed type, video channel type, social stream type, photo type, products-for-sale type, user-generated articles type that includes citizen journalism, etc. The type of a section 308 may be a factor in how access permissions are provided to the section by access control unit 140. For example, section access may be provided to citizen journalism sections, but not to video sections.

Each section 308 may have a custom design. In an embodiment, the custom design may be rendered from templates 216 that layout the content of each section 308. As described herein, templates 216 may be native templates provided by studio backend 126 or may be custom templates that are designed for a particular edition 306 or section 308 by publisher 120. In another embodiment, templates 216 may be used to render section 308 on a mobile device 106 that include display screens of different sizes, such as, for example, a tablet and a mobile phone.

Each section 308 includes posts 310. Post 310 represents data associated with a particular unit of content, such as an article, a video, a single image, a “tweet”, a slide show, a map, or any unit of content within content source 118. In an embodiment, post 310 includes multiple items 312. Each item 312 includes information associated with post 310. Example items 312 may include information such as a title, a body, an author, a byline, a media, etc. Depending of what items 312 are included in post 310, post 310 may display a video, an article, a shopping cart item, etc. The items 312 included in a post 310 may be a factor in how access permissions are provided to the post 310 by access control unit 140. For example, post access may be provided for a photographer to media aspects of post 310, but not to body aspects of post 310.

Because of the flexibility of application data model 134, a synchronization process of the new edition content 132 received from content sources 118 may be performed on a granularity level of each post 310, and without updating content included in entire edition 306 or section 308. However, as noted, synchronization can only occur to the extent permitted by access control unit 140.

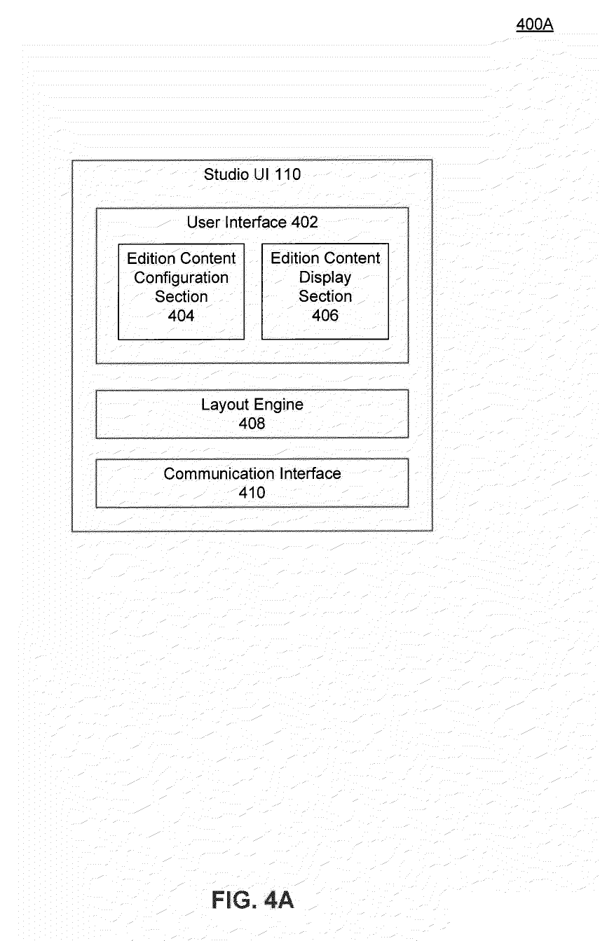

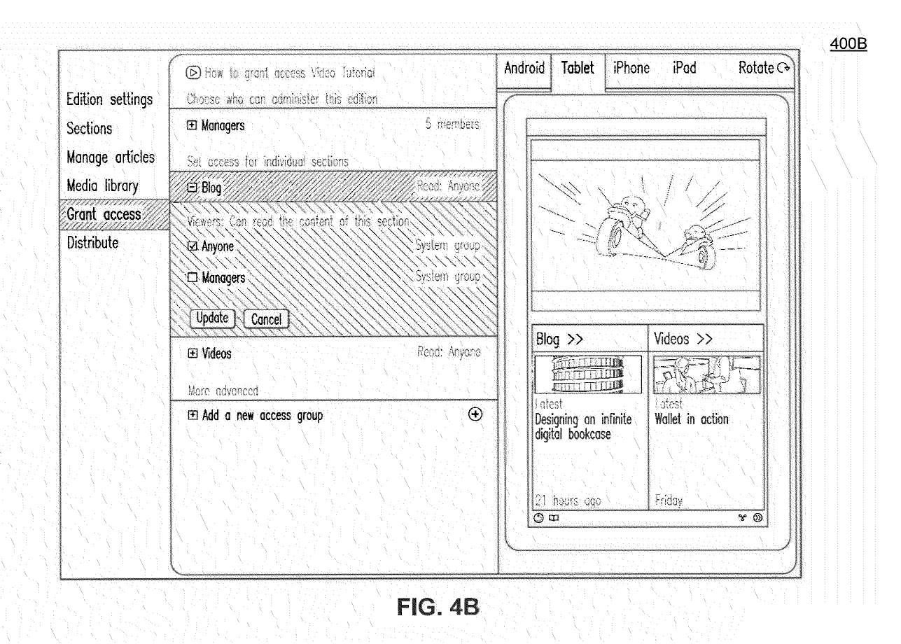

FIG. 4A is a block diagram 400A of a studio architecture, according to an embodiment. Studio UI 110 includes a user interface 402. User interface 402 allows publisher 120 to configure the layout of edition content 132 that is included in magazine edition 112. User interface 402 includes an edition content configuration section 404 and an edition content display section 406. Edition content configuration section 404 allows publisher 120 to select content source 118 that provides edition content 132 for display using magazine edition 112. Edition content configuration section 404 further allows publisher 120 to select multiple sections 308 to display edition content 132. As described herein, example sections 308 may include a news section, a video section, etc. Within each section 308, publisher 120 may further configure content source 118 that provides edition content 132 and template 216 that determines the format in which edition content 132 is displayed on mobile device 106. Edition content configuration section 404 also allows publisher 120 to tailor the display of edition content 132 to a particular mobile device 106.

Edition content configuration section 404 also allows publisher 120 to configure the user population that views edition content 132 provided by magazine edition 112. For example, each section 308 within magazine edition 112 may be configured for viewing by any user, a select group of users, etc.

Edition content configuration section 404 also allows publisher 120 to select advertisers that may provide advertisements to magazine edition 112. For example, when magazine edition 112 displays edition content 132 on mobile device 106, magazine edition 112 may query an advertiser and retrieve advertisements that may be integrated with edition content 132 and be displayed to a user.

Edition content configuration section 404 allows publisher 120 to select merchandise items that may be includes for sale in magazine edition 112. Edition content configuration section 404 also allows publisher 120 to configure a check out interface so that users are able to purchase the merchandise items that are offered for sale.

Edition content configuration section 404 allows publisher 120 to distribute magazine edition 112 to mobile devices 106 or edition distributors 124.

It may be noted, however, that the operation of edition content configuration section 404 will be constrained by access control unit 140, and publisher 120 will only be able to perform the above tasks to the extent that publisher 120 is associated with appropriate access permissions.

Edition content display section 406 displays edition content 132 from content sources 118 that are included in each magazine edition 112. In an embodiment, edition content display section 406 displays edition content 132 as it may be displayed on various mobile devices 106, such as a tablet or a smart phone. For example, publisher 120 may select to simulate edition content 132 using a particular mobile device 106. Additionally, edition content display section 406 allows publisher 120 to preview the display of edition content 132 using a vertical or horizontal orientation on mobile device 106.

Studio UI 110 also includes a layout engine 408. Layout engine 408 allows publisher 120 to preview edition content 132 as it may be displayed on mobile devices 106 having a particular specification. For example, layout engine 408 determines the size of the display screen of the mobile device 106 that a user selects to preview edition content 132. Layout engine 408 then uses the size of the display screen to format the content in columns as it may be displayed on mobile device 106.

Studio UI 110 includes a communication interface 410. Communication interface 410 receives edition content 132 from data storage 128 for content source 118 that publisher 120 selects for display using magazine edition 112. Publisher 120 may use the received edition content 132 to design sections 308 that display edition content 132 or simulate a layout of edition content 132 on mobile devices 106. In an embodiment, mobile device 106 may also use communication interface 410 to distribute magazine edition 112 when they are ready for distribution.

FIG. 4B is a screen shot of an exemplary embodiment of a studio displaying a user interface. For example, FIG. 4B shows a studio where a magazine edition 112 is being constructed for a tablet. However, it can be readily seen that alternative devices, such as smart phones, may have content tailored for them in the studio.

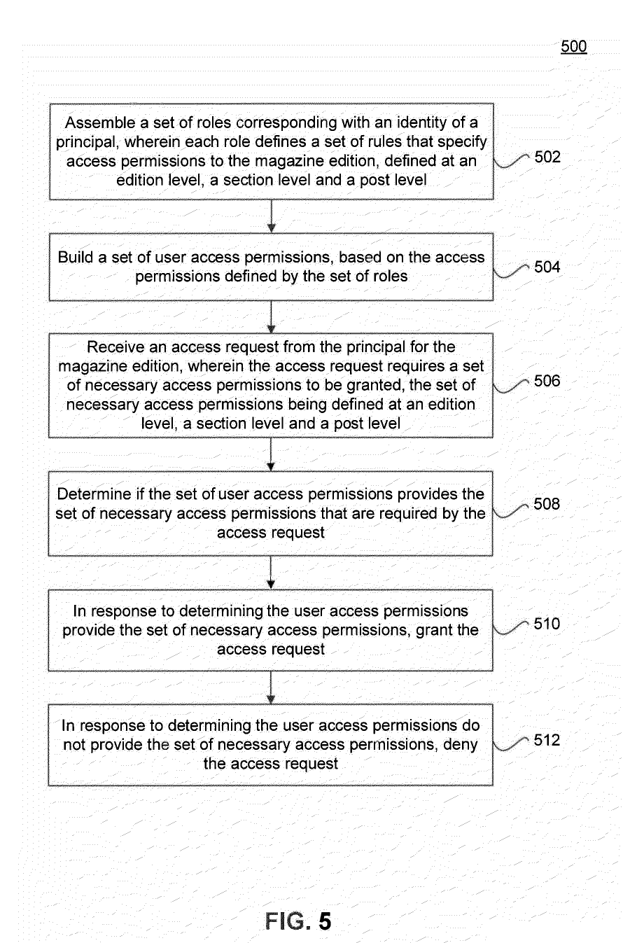

FIG. 5 is a flowchart of a method 500 for managing access control for a magazine edition, according to an embodiment.

At stage 502, a set of roles are assembled that correspond with an identity of a principal, wherein each role defines a set of rules that specify access permissions to the magazine edition, defined at an edition level, a section level and a post level.

For example, principal identifier 142 of access control unit 140 identifies a principal. As discussed above, the identification process may involve submission of a user id and password, presentation of biometric data, or using a previously ascertained identity of the principal. If there is a problem identifying the principal, principal identifier 142 may allow an alternative identification process. If the principal cannot be established, method 500 may proceed using a default principal, such that the default principal has a set of default roles, which may be a null set.

Furthermore, role assembler 144 of access control unit 140 assembles the set of roles from role storage 146. As discussed above, this set of roles may be a set of default roles, which may be a null set. An example of how this stage is carried out is provided in FIG. 6. However, in general, the identity of the principal maps to a set of roles in role storage 146, and role assembler 144 retrieves these roles.

At stage 504, a set of user access permissions is built based on the access permissions defined by the set of roles. For example, role assembler 144 of access control unit 140 builds the set of user access permissions based on the set of roles retrieved from role storage 146. An example of how this stage is carried out is provided in FIG. 6. However, in general this stage is carried out in two ways, based on the nature of the roles. If the roles are predefined, then the roles will define specific access permissions based on the nature of the roles. However, there may also be user-defined roles that provide for rules that in turn specify access permissions. In this case, the user-defined roles retrieved form role storage 146 include rules, and these rules are then interpreted by role assembler 144 to build the set of user access permissions. In general, the rules are stored in such a way that the rules can be parsed by role assembler 144 to specify access permissions.

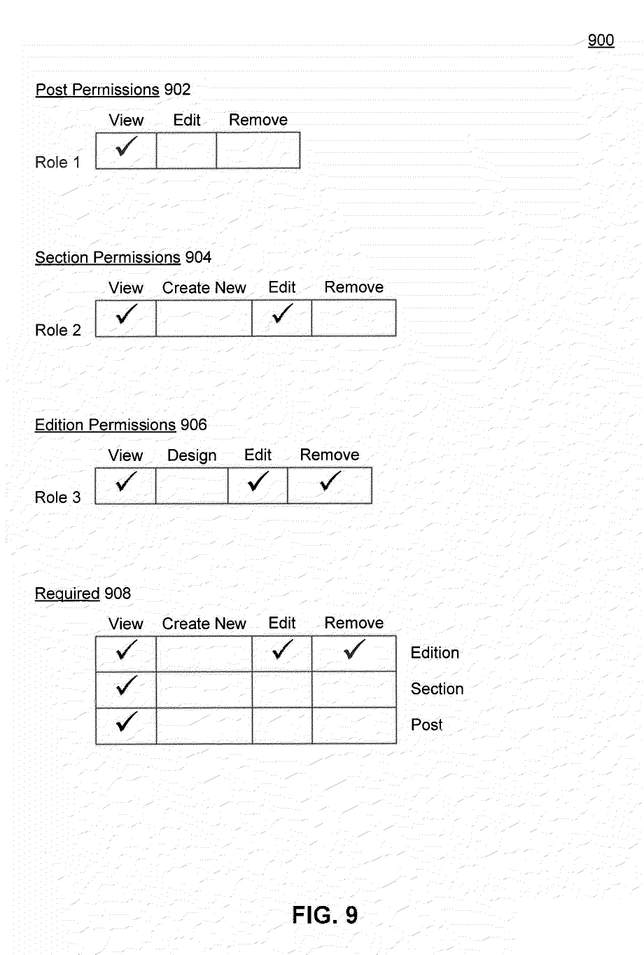

At stage 506, an access request is received from the principal for the magazine edition, wherein the access request requires a set of necessary access permissions to be granted, the set of necessary access permissions being defined at an edition level, a section level and a post level. For example, access request receiver 148 may receive the access request from the principal. An example of how such a request might be provided is shown in FIG. 9. For example, access request receiver might receive a request of specific permissions for a given edition, section, and post.

At stage 508, it is determined if the set of user access permissions provides the set of necessary access permissions that are required by the access request. For example, permission determiner 150 may determine if the set of user access permissions is sufficient. Essentially, this task may be accomplished by comparing the access permissions in the user access permissions generated by role assembler 144 to those required in the access request provided to access request receiver 148. The required permissions must be present for the appropriate edition, section, and post.

At stage 510, in response to determining the user access permissions provide the set of necessary access permissions, the access request is granted. For example, access manager 154 may grant the access request if permission determiner 150 determines that necessary access permissions have been provided. Access manager 154 grants the access request by sending an appropriate signal to studio backend 126 for further handling. This determination was made during stage 510, as discussed previously.

At stage 512, in response to determining the user access permissions do not provide the set of necessary access permissions, the access request is denied. For example, access manager 154 may deny the access request if permission determiner determines that necessary access permissions have not been provided. Access manager 154 denies the access request by sending an appropriate signal to studio backend 126 for further handling. This determination was made during stage 510, as discussed previously.

FIG. 6 is a diagram of the relationship between a principal, a role set, associated rules, and associated access permissions 600, according to an embodiment. The diagram of FIG. 6 illustrates a principal 602 that has been associated with a role set 604. The way in which this association is accomplished has been discussed, above. In the example of FIG. 6, role set 604 includes role A 610 and role B 620. In general, roles may be defined either as predefined roles that operate at specific levels of granularity, or as user-defined roles that may be established with greater specificity. For example, an example of a predefined role may be that principal 602 is a manager at the edition level, or a reader at the post level. For these predefined roles, the role will define a set of corresponding permissions. While further predefined roles and permissions are discussed in greater detail later, if principal 602 is a manager at the edition level, it may provide that principal 602 will have view, design, edit, and remove permissions at the edition level. Alternatively, if principal 602 is a reader at the post level, principal 602 may have view access to the post in question.

It is important to note that these predefined roles provide permissions that are specific to a given level. For example, principal 602 may have read permissions at the edition level, but an edition may be structured so that access control unit 140 requires additional permissions at other levels. For example, even if principal has read permission at the edition level, certain sections or posts must have specific permission at those levels in order to access certain content. For example, a certain section may only be accessible by a Peruvian principal, or a certain post may only be accessible based upon payment of a fee.

However, roles may also be user-defined based on rules. This approach provides greater flexibility than that provided by predefined roles. For example, suppose that access control unit 140 is managing access for principal 602 to an international news magazine. Suppose that principal 602 has subscribed to the free Mexican edition of the magazine, and has also paid a fee for access to a financial section. Suppose further that principal 602 is a citizen journalist, so that principal 602 may access information from the crime section and post photos.

Thus, in this example, role A 610 may represent the relationship between principal 602 and the magazine due to the subscriptions by the principal 602. For example, role A 610 may include rule A1 612 and rule A2 614 that define sets of access privileges based on role A 610. For example, rule A1 612 may be “allow view access to free content of Mexican edition.” Rule A2 614 may be “allow view access to paid financial content of Mexican edition.”

While these rules have been characterized as simple phrases, it may be noted that the rules associated with roles may be stored in various ways in role storage 146. Essentially, a rule will generally define certain types of access permissions which are available, and certain types which are not. As noted above, these access permissions are characterized as available at edition-level, section-level, and post-level.

Thus, to establish access permissions, a rule will define specific access permissions for specific types of content. While simple examples are presented above, rules may be used in more sophisticated manners. For example, a rule might provide that principal 602 is to be granted complete access (including permissions such as viewing, creating, editing, and removing) to all content related to theater, regardless of whether the access is edition-level based, section-level based, or post-level based. Thus, rules provide a principal with an opportunity to address permissions in a comprehensive, flexible manner.

Thus, rules generally provide that certain types of access permissions are to be granted for specific parts of magazine edition 112. Rules may be represented in role storage 156 in a variety of ways, such as a markup or scripting language, a flowchart, natural language, or any other way that role assembler 154 can recognize to derive access permissions corresponding with the roles.

Continuing with the example, rule A1 612 may be associated with three actual sets of permissions, edition-level access permissions 612A, section-level access permissions 612B, and post-level access permissions 612C. For this example, rule A1 612 defines a edition-level access permission for the Mexican magazine edition 112 of view, and rule A2 614 defines a section-level access permission for the financial section Mexican magazine edition 112 of view. While each of these rules defines one access permission at one level, as noted above more comprehensive access permissions are certainly possible.

Role B 620 may represent the relationship between principal 602 and the magazine due to principal 602 acting as a citizen journalist.

For example, role B 620 may include rule B1 622 and rule B2 624 that define sets of access privileges based on role B 620. For example, rule B1 622 may be “allow editor access to news-related section of Mexican edition.” Rule B2 624 may be “allow author access to crime-related posts of Mexican edition.”

In this example, rule B1 622 may be associated with three actual sets of permissions, edition-level access permissions 612A, section-level access permissions 612B, and post-level access permissions 612C. For this example, rule B1 612 defines a section-level access permission for news-related sections of Mexican magazine edition 112 of view. However, as can be seen, this rule is a more general rule, and role assembler 154 in turn will grant editor access to multiple news related sections, such as appropriate international, national, and local sections. Similarly rule B2 614 defines a post-level access permission for crime-related posts within Mexican magazine edition 112 of view. Thus, rule B2 will allow principal 602 to author crime-related content posts, such as photos, articles, blog entries, or videos in the context of Mexican magazine edition 112.

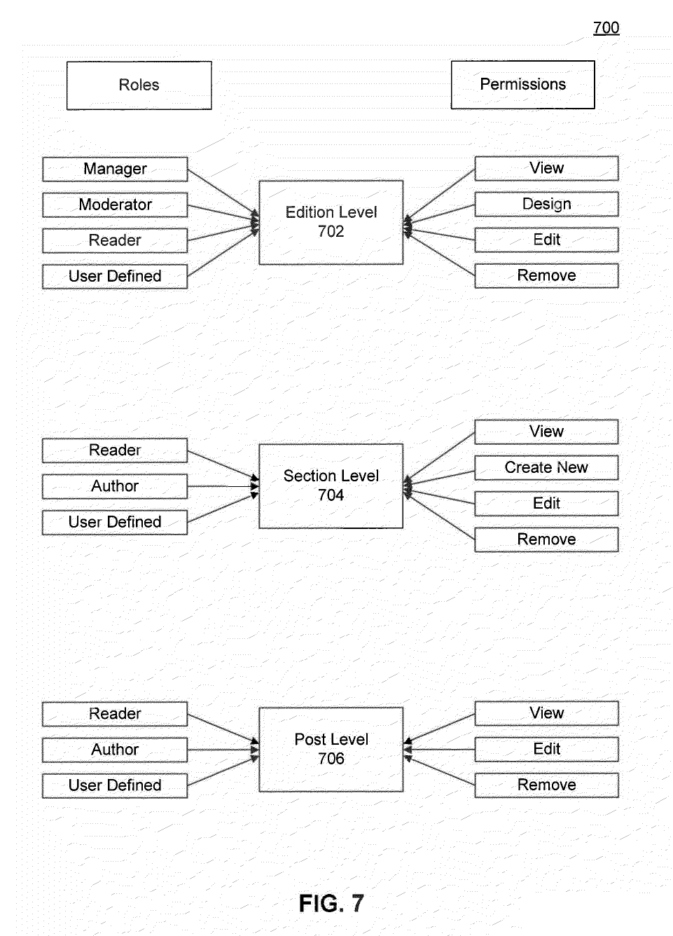

FIG. 7 is a diagram 700 showing potential roles and permissions available at various levels of granularity, according to an embodiment. As can be seen in FIG. 7, magazine edition 112 operates at three levels: an edition level 702, a section level 704, and a post level 706. Each of the levels is associated with certain specific choices for roles and permissions that can operate at a given level.

For example, edition level 702 may include predefined roles such as manager, moderator, reader, or a user defined role. The specific permissions associated with predefined roles may vary by embodiment. Permissions at the edition level may include view, design, edit, and remove. View permission allows a principal to see items within the edition. Design permission allows a principal to add new content to the edition. Edit permission allows a principal to change content in the edition. Remove permission allows a principal to delete content in the edition.

Section level 704 may include predefined roles such as reader, author, or a user defined role. The specific permissions associated with predefined roles may vary by embodiment. Permissions at the section level may include view, create new, edit and remove. View permission allows a principal to see items within the section. Create new permission allows a principal to create new posts within the section. Edit permission allows a principal allows a principal to change content in the section. Remove permission allows a principal to remove content in the section.

Post level 706 may include predefined roles such as reader, author, or a user defined role. The specific permissions associated with predefined roles may vary by embodiment. Permissions at the post level may include view, edit, and remove. View permission allows a principal to see the post. Edit permission allows a principal allows a principal to change content in the post. Remove permission allows a principal to remove content in the post.

FIG. 8 is an example computer system 800 in which embodiments of the present invention, or portions thereof, may be implemented as computer-readable code. For example, the components or modules of magazine edition system 100, such as studio UI 110, magazine editions 112, current module 115, studio backend 126, access control unit 140, etc., may be implemented in one or more computer systems 800 using hardware, software, firmware, tangible computer-readable media having instructions stored thereon, or a combination thereof and may be implemented in one or more computer systems or other processing systems. Modules and components in FIGS. 1-7 may be embodied in hardware, software, or any combination thereof.

Mobile device 106, web server 104 and producer server 108 may include one or more computing devices that include a computer system 800. Computer system 800 may include one or more processors 802, one or more non-volatile storage mediums 804, one or more memory devices 806, a communication infrastructure 808, a display screen 810 and a communication interface 812.

Processors 802 may include any conventional or special purpose processor, including, but not limited to, digital signal processor (DSP), field programmable gate array (FPGA), and application specific integrated circuit (ASIC).

GPU 814 is a specialized processor that executes instructions and programs, selected for complex graphics and mathematical operations, in parallel.

Non-volatile storage 804 may include one or more of a hard disk drive, flash memory, and like devices that may store computer program instructions and data on computer-readable media. One or more of non-volatile storage device 804 may be a removable storage device.

Memory devices 806 may include one or more volatile memory devices such as but not limited to, random access memory. Communication infrastructure 808 may include one or more device interconnection buses such as Ethernet, Peripheral Component Interconnect (PCI), and the like.

Typically, computer instructions are executed using one or more processors 802 and can be stored in non-volatile storage medium 804 or memory devices 806.

Display screen 810 allows results of the computer operations to be displayed to a user or an application developer.

Communication interface 812 allows software and data to be transferred between computer system 800 and external devices. Communication interface 812 may include a modem, a network interface (such as an Ethernet card), a communications port, a PCMCIA slot and card, or the like. Software and data transferred via communication interface 812 may be in the form of signals, which may be electronic, electromagnetic, optical, or other signals capable of being received by communication interface 812. These signals may be provided to communication interface 812 via a communications path. The communications path carries signals and may be implemented using wire or cable, fiber optics, a phone line, a cellular phone link, an RF link or other communications channels.

Embodiments also may be directed to computer program products comprising software stored on any computer-useable medium. Such software, when executed in one or more data processing device, causes a data processing device(s) to operate as described herein. Embodiments of the invention employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nano-technological storage device, etc.).

FIG. 9 is a set of exemplary permission tables that illustrate an example of how user permissions are processed. For example, suppose that principal 602 wishes to view a particular post within a particular section of a particular edition. Principal 602 may be associated with post permissions 902 based on role 1, section permissions 904 based on role 2, and edition permissions 904 based on role 3. With respect to this particular piece of content, it can be seen that principal 602 has view permission at the post level, view and edit permissions at the section level, and view, edit, and remove permissions at the edition level.

FIG. 9 also shows a set of required permissions 908 that correspond to a given access request. In the example show, it is required that principal have view, edit, and remove permissions at the edition level, view permission at the section level, and view permission at the read level. Thus, it can be seen that all necessary access permissions are present for principal 602. In fact, principal 602 even has a superfluous permission, in that the section permission 604 of edit is not required for the access permission. Thus, that permission could be absent and the access request would still be granted. However, if one of the required permissions 908 was not present, access control unit 140 would deny the access request.

In an embodiment that uses permission tables, building a set of user access permissions may further comprise storing the set of user access permissions in a permissions table. Additionally, determining if the set of user access permissions provides the set of necessary access permissions that are required by the access request may further include checking the permissions table for the presence of the set of necessary access permissions.

Additional features are also present in various embodiments. For example, part of identifying a user as a principal may involve authentication. Such authentication may proceed by receiving login information from the principal, and verifying the login information to identify and authenticate the principal.

Furthermore, roles may define rules to specify access permissions based on personal attributes of the principal, or based on relationships between the principal and an embodiment. For example, rules to specify access permissions may incorporate a payment status of the principal, such that the principal only has access after paying a certain fee. Alternatively, access permissions may be based on a location of the principal. For example, access to local news for South Africa may only be available to users in South Africa. Another option for access permissions is that they may be based on a contributor status of the principal. For example, the principal may have a contributor status, such as being a reporter, a citizen journalist, a copyeditor, a photographer, or so on. Based on the contributor status of a principal, he or she may be provided with certain access permissions.

As discussed in connection with FIG. 9, building a subject further comprises storing the set of access permissions in a permissions table and determining if the subject provides the necessary access permissions further comprises checking the permissions table for the presence of the necessary access permissions.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

What is claimed is:

1. A method for managing access control for a magazine edition, the method comprising:
assembling a set of roles corresponding with an identity of a principal, wherein each role defines a set of rules that specify access permissions to the magazine edition, defined at an edition level, a section level and a post level;
building a set of user access permissions, based on the access permissions defined by the set of roles;
receiving an access request from the principal for the magazine edition, wherein the access request requires a set of necessary access permissions to be granted, the set of necessary access permissions being defined at an edition level, a section level and a post level;
determining if the set of user access permissions provides the set of necessary access permissions that are required by the access request;
in response to determining the user access permissions provide the set of necessary access permissions, granting the access request; and
in response to determining the user access permissions do not provide the set of necessary access permissions, denying the access request.

2. The method of claim 1, further comprising establishing an identity of a principal, wherein establishing the identity of the principal comprises:
receiving login information associated with the principal; and
verifying the login information to identify and authenticate the principal.

3. The method of claim 1, wherein roles define rules to specify access permissions based on a payment status of the principal.

4. The method of claim 1, wherein roles define rules to specify access permissions based on a location of the principal.

5. The method of claim 1, wherein roles define rules to specify access permissions based on a contributor status of the principal.

6. The method of claim 1, wherein access requests comprise: view, design, edit, remove, and create new.

7. The method of claim 1, wherein roles comprise one or more of: readers, authors, managers, moderators, and user-defined roles.

8. The method of claim 1, wherein access permissions comprise one or more of: view, design, create new, edit, and remove.

9. The method of claim 1, wherein:
building a set of user access permissions further comprises storing the set of access permissions in a permissions table, and
determining if the set of user access permissions provides the necessary access permissions further comprises checking the permissions table for the presence of the necessary access permissions.

10. A system for managing access control for an online magazine, comprising:
an access control unit, configured to:
assemble a set of roles corresponding with an identity of a principal, wherein each role defines a set of rules that specify access permissions to the magazine edition, defined at an edition level, a section level and a post level;
build a set of user access permissions, based on the access permissions defined by the set of roles;
receive an access request from the principal for the magazine edition, wherein the access request requires a set of necessary access permissions to be granted, the set of necessary access permissions being defined at an edition level, a section level and a post level;
determine if the set of user access permissions provides the set of necessary access permissions that are required by the access request;
in response to determining the user access permissions provide the set of necessary access permissions, grant the access request; and
in response to determining the user access permissions do not provide the set of necessary access permissions, deny the access request.

11. The system of claim 10, wherein the access control unit is further configured to establish an identity of a principal, wherein establishing the identity of the principal comprises:
receiving login information associated with the principal; and
verifying the login information to identify and authenticate the principal.

12. The system of claim 10, wherein roles define rules to specify access permissions based on a payment status of the principal.

13. The system of claim 10, wherein roles define rules to specify access permissions based on a location of the principal.

14. The system of claim 10, wherein roles define rules to specify access permissions based on a contributor status of the principal.

15. The system of claim 10, wherein access requests comprise: view, design, edit, remove, and create new.

16. The system of claim 10, wherein roles comprise one or more of: readers, authors, managers, moderators, and user-defined roles.

17. The system of claim 10, wherein access permissions comprise one or more of: view, design, create new, edit, and remove.

18. The system of claim 10, wherein:
building a set of user access permissions further comprises storing the set of access permissions in a permissions table, and
determining if the set of user access permissions provides the necessary access permissions further comprises checking the permissions table for the presence of the necessary access permissions.

19. A computer-readable storage medium having control logic stored therein that, when executed by one or more processors, causes the processors to manage access control for an online magazine, the control logic comprising:
a first computer-readable program code to cause the processors to:
assemble a set of roles corresponding with an identity of a principal, wherein each role defines a set of rules that specify access permissions to the magazine edition, defined at an edition level, a section level and a post level;
build a set of user access permissions, based on the access permissions defined by the set of roles;
receive an access request from the principal for the magazine edition, wherein the access request requires a set of necessary access permissions to be granted, the set of necessary access permissions being defined at an edition level, a section level and a post level;
determine if the set of user access permissions provides the set of necessary access permissions that are required by the access request;
in response to determining the user access permissions provide the set of necessary access permissions, grant the access request; and
in response to determining the user access permissions do not provide the set of necessary access permissions, deny the access request.
